(19) United States
(12) Patent Application Publication
(10) Pub. No.: US 2010/0310945 A1
(43) Pub. Date: Dec. 9, 2010

(54) BIOLOGICAL FUEL CELL

(75) Inventors: Giuliano Claudio Premier, Wales (GB); Christopher Pickett, Norwich (DE); Alan Jon Guwy, Wales (GB); Richard Mark Dinsdale, Wales (GB)

Correspondence Address: MERCHANT & GOULD PC, P.O. BOX 2903, MINNEAPOLIS, MN, 55402-0903, US

(73) Assignee: UGCS (UNIVERSITY OF GLAMORGAN COMMERCIAL SERVICES), MID GLAM (GB)

(21) Appl. No.: 12/601,210

(22) PCT Filed: Mar. 31, 2008
(86) PCT No.: PCT/GB08/01118

§ 371 Date: Aug. 26, 2010

(30) Foreign Application Priority Data
May 22, 2007 (GB) 0709810.6

(51) Int. Cl. H01M 8/16; H01M 8/02; H01B 1/00

(52) U.S. Cl. 429/401; 429/512; 252/500

(57) ABSTRACT

A fuel cell includes an anode 5, a cathode 7, a catalyst, an electrolytic fluid 4, a substrate, a fluid chamber 1 and a mobile capacitive particles 10,20 that are capable of storing charge. In operation, the charged capacitive particles 10 transfer electrons generated in an electrochemical reaction to the anode 5.

The invention relates to fuel cells suitable for generating electricity especially biological fuel cell systems such a microbial fuel cells (MFCs).

### BACKGROUND TO THE INVENTION

In a fuel cell an electrochemical reaction involving a substrate occurs in the presence of a catalyst. In a conventional fuel cell the catalyst is an inorganic catalyst whilst in a biological fuel cell the catalyst is a biological catalyst such as an enzyme or, in the case of a microbial fuel cell (MFC), a bacterium or microbe. The substrate, sometimes referred to as the fuel of the fuel cell, is a substance that is consumed in the electrochemical reaction. Conventional fuel cell substrates typically include hydrogen gas and hydrocarbons such as methane. In a biological or microbiological fuel cell the substrate typically includes complex organic compounds such as volatile fatty acids, starches and sugars that are digested by the enzymes or bacteria of the cell. Substrate is loaded into a chamber in which the anode is situated (the “anode chamber”) and reacts in an electrochemical reaction catalysed by the catalyst to produce electrons and positively charged ions. In order for an electrical circuit to be completed, electrical charge must be transferred between the electrochemical reaction site and the electrodes. The electrons produced in an electrochemical reaction in a fuel cell flow from the anode through an external circuit (load) to the cathode. The positive ions (cations) travel through the electrolyte to the cathode. At the cathode electrons are combined with cations in a further electrochemical reaction. In some instances an ion-exchange membrane is present that separates the fluid-containing chamber of a fuel cell into an anode chamber and a separate cathode chamber. The positive charge is transferred from cations in the anode chamber across the ion-exchange membrane to form cations in the cathode chamber.

In a standard MFC, substrate is consumed by the bacteria in generating their life energy through an electron transport chain of reactions which can be subverted to partake in the electrochemical reaction. Bacteria in an anode chamber catalyse the oxidation of a substrate during bacterial cell respiration. The electrons produced from that bacterial cell respiration are released to the anode, either directly or via a mediator. Positively charged ions such as protons are also released into a fluid electrolyte present in the anode chamber.

The use of mediators, which are also known as “shuttling compounds”, to transfer charge from bacteria to the anode in an MFC has previously been described. For example, Ieropoulos et al., in “Energy accumulation and improved performance in microbial fuel cells”, Journal of Power Sources, 2005, 145, 253-256 describe the use of sulphide/sulphate ions as a redox mediator in MFCs.

The term “fuel cell” used herein encompasses both conventional systems that are used to generate electricity and other systems in which substrate is consumed in an electrochemical process involving an electrical circuit. Thus, the term “fuel cell” may include waste and effluent treatment systems and the like in which the primary purpose is to consume waste matter rather than to generate electricity. In some embodiments of the invention electric energy may be supplied to the system in order to drive the electrochemical processes involved in consuming substrate.

Developments in fuel cell design have been driven by the need to maximise current density with respect to anode area or volume. However, fuel cells and microbial fuel cells (MFCs) in particular are limited in several senses in their current state of development. A critical issue is the spatial arrangement of the anode and cathode, regardless of the presence or absence of an ion-exchange membrane. A compromise exists between various over-potentials related to ohmic, activation and mass transfer losses and volume available for bacteria or other catalyst and the substrate. In general, the larger the volume of the cell the less efficient it will be in transferring charge from the electrochemical reaction site to an electrode. Increased separation between the catalyst and electrode or turbulent fluid flow patterns will induce ohmic losses. Mass transfer and activation losses arise from substrate inhibition of catalytic sites or concentration gradients limiting access of the catalyst to the substrate and those are losses affected by local environments about the catalyst site. Ohmic losses in the electrode are also dependent on the scale of the reactor, the distance to the electrode and the surface area of the electrode compared to the fluid volume. Attempts to increase anode area can result in a reduction in conductivity of the anode. For example, carbon electrodes of a woven, porous or veil-like construction can result in reduced conductivity due to inefficient transfer of electrons from one fibre to another or at material grain structure interfaces.

It is desirable for biological reactors to retain large volumes of liquids enabling large quantities of substrate-containing fluid to be loaded into the reactor. For example, conventional non-electrolytic biological reactors typically have reaction chamber volumes of at least 50 Litres and in some instanced significantly more, such as volumes of greater than 500 Litres. It is also preferable in a biological reactor for large quantities of biomass comprising a biological catalyst to be retained in the reactor. The ability of a biological reactor to retain a large quantity of biomass enables a large quantity of substrate to be rapidly consumed in the reactor. In a large biological reactor, retention of large quantities of biomass may be accomplished by settling or membrane separation of bacteria or by facilitating the agglomeration of bacteria into biofilms, flocks or granules which are more easily retained in the reactor. Fluidised bed systems use a carrier medium which becomes colonised by bacteria which form a biofilm on the surface of the carrier medium. A difficulty with using a similar large reactor arrangement to contain the anode chamber of a conventional biological fuel cell is that high (so called) overpotential losses would be incurred due to the resistance of the fluid and the distance to a localised anode. An anode that is distributed through the chamber as a plurality of plates, dendritic attachments, a matrix or as a mesh or the like may, to some extent, alleviate the losses due to distance to the anode but the distributed anode would impede the mass transfer which is needed to supply substrate to the biological catalyst and to remove inhibitory products from the vicinity of the biological catalyst. An example of a distributed anode is that described in by Rabaey et al in “Tudular Microbial Fuel Cells for Efficient Electricity Generation”, Environ. Sci. Technol., 2005, 39, 8077-8082 where the anode chamber includes graphite granules that are immobilised as an anode matrix and function as an anode that is distributed in the anode chamber.

Accordingly, current MFC designs are limited to anode chamber volumes of the order of 10 Litres. High power systems (circa 20 to 350 mW and above) often employ a modular arrangement with a plurality of cells of dimensions of the order of 1 Litre or frequently less. The ideal situation would be to have reactor volumes several orders of magnitude greater. A fuel cell that operates efficiently with large reactor volumes of 50 Litres or more may help enable biological waste water treatment processes currently using activated sludge processes, anaerobic digestion processes (e.g. UASB, EGSB, Packed bed reactors, CSTR, Fluidised bed and systems employing recirculation of settled sludge) or sequencing batch reactors and the like to be operated as fuel cells using similar technologies. Biological fuel cell systems which involve a small number of large tank systems as opposed to a similar volume made up of a large number of small cells or modules would be highly desirable for the commercialisation and scale-up of MFCs and their application to various ‘fuels’ such as particulate organic substrates, waste waters and the like.

### DESCRIPTION OF THE INVENTION

The invention provides a fuel cell comprising an anode, a cathode, an electrolytic fluid, a fluid chamber, a substrate, a catalyst and a plurality of capacitive particles for transferring to the anode electrons generated in an electrochemical reaction of the substrate at the catalyst. Capacitive particles are mobile particles that act as capacitors to store electrical charge. The fluid chamber is a chamber that holds the electrolytic fluid and in which at least the anode is situated. The electrolytic fluid is a fluid capable of solvating ions and is typically an aqueous electrolyte, such as a salt solution or complex mixture of solutes. In operation of the fuel cell, the capacitive particles are supported in and move through the electrolytic fluid, for example, the capacitive particles may be suspended in the electrolytic fluid at some stages of the operation of the fuel cell. The catalyst is suitable for catalysing the electrochemistry of the fuel cell as is discussed in further detail below.

The substrate is the fuel that is consumed in the electrochemical reaction of the fuel cell. Typically, the substrate will be supported in the electrolytic fluid.

The invention also provides a method of operating a fuel cell in which charge is transferred from an electrochemical reaction site to a localised electrode via capacitive particles. In particular, a method in which electrons are conveyed to an anode by capacitive particles acting as charge carriers. The invention further provides an apparatus comprising an anode, a cathode, a fluid chamber and a plurality of capacitive particles, the apparatus being suitable for use as a fuel cell. The invention further provides capacitive particles for use in the fuel cell of the invention. In one embodiment the invention provides a synthetic capacitive particle able to carry charge produced in an electrochemical reaction in a fuel cell to an anode. The invention further provides a waster water treatment system comprising an anode, a cathode, a catalyst and a plurality of mobile capacitive particles that are capable of storing electrical charge.

### DETAILED DESCRIPTION

The cell is optionally a microbial fuel cell (MFC) and the catalyst comprises bacteria, for example, anodophilic bacteria. The capacitive particles optionally have a charging threshold potential of at least −80 mV with respect to a Standard Hydrogen Electrode. Optionally, each capacitive particle has an average capacitance of at least 0.1 pF. Optionally, the capacitive particles comprise a synthetic material, for example, a composite material. Optionally, the capacitive particles comprise a chemical capacitor. Optionally, the capacitive particles each have an average volume of at least 0.1 mm³. Optionally, the capacitive particles each have an average drag coefficient (C_{d}) of at least 0.005. Optionally, the capacitive particles include the catalyst. Optionally, the capacitive particles include a redox mediator. Optionally, the capacitive particles each have a specific gravity of at least 1.0. Optionally, the fluid chamber has a volume of at least 20 Litres. Optionally, the cell further comprises a driver for driving movement of the capacitive particles. Optionally, the fluid chamber comprises a first compartment or region and a second compartment or region in which the anode is present. Optionally, the cell is arranged so that capacitive particles are periodically concentrated into the second compartment or region, for example, the cell is arranged so that charged capacitive particles are selectively concentrated into the second compartment or region. Optionally, the cell comprises a separator for concentrating capacitive particles into a second compartment or region. The method advantageously includes the steps of: generating electrons in an electrochemical reaction involving the substrate that is catalysed by the catalyst; charging the capacitive particles with the electrons; moving the capacitive particles or allowing the capacitive particles to move relative to the anode; and discharging electrons from the capacitive particles to the anode.

Optionally, the method includes the steps of concentrating charged capacitive particles prior to discharging electrons from the charged capacitive particles to the anode, for example, the particles may be concentrated under the influence of an electrical or magnetic field. Optionally, the method includes the steps of settling the capacitive particles. Optionally, the capacitive particles are synthetic capacitive particles having a range of potentials from about −180 mV to about −500 mV with respect to a Standard Hydrogen Electrode.

The capacitive particles are suitable for circulating in the electrolytic fluid of the fluid chamber in which the anode is situated. In operation of the fuel cell the capacitive particles move relative to the anode. The capacitive particles advantageously circulate whilst suspended in the electrolytic fluid and act as small open circuit anodes to accumulate charge. The capacitive particles then periodically discharge on contact with the localised anode. In operation of the fuel cell, electrolytic fluid is contained in the fluid chamber in which the anode is present. Fluid may flow through the fluid chamber, for example as a continuous flow or a recirculatory flow, or be retained in the fluid chamber.

The cathode may also be present in the fluid chamber in which the anode is situated or may be present in a cathode chamber that is separated from the fluid chamber, for example by an ion exchange membrane. During operation of the cell, the capacitive particles are generally mobile in the electrolytic fluid of the fluid chamber. For example, the capacitive particles may be suspended in the electrolytic fluid. The capacitive particles may periodically be stationary, for example when brought into contact with the anode to discharge. The capacitive particles may be caused to move by a driving means.

The carrying of charge through the electrolytic fluid by the capacitive particles may allow charge to be carried for relatively large distances (for example distances of the order to 20 cm or more and in some instances 100 cm or more) without significant loss of charge. Thus, the fuel cells of the invention may alleviate the over-potential losses in standard cells caused when charge has to be transferred across large distances, for example when transferred by naturally-occurring redox mediators or redox mediators that are in solution in the electrolyte fluid. Conventional mediation utilises environmentally toxic redox active chemicals which are undesirable for this reason. Furthermore, the invention may alleviate the need for anodes distributed in an anode chamber that cause mass transfer limitations.

The inclusion of a large number of these capacitive particles in a cell may allow the harvesting of electrons over a large fluid chamber volume, thereby enabling large scale cells to be viable, for example cells having an electrolyte volume of more than 20 Litres. The fuel cells of the invention may have fluid chamber volume of at least 50, preferably at least 100, more preferably at least 200 and especially at least 500 Litres or more. The invention may thus enable the application of well understood and tested large scale reactor designs used in conventional non-electrolytic biological processes in fuel cells, especially MFCs (albeit adapted for electrochemical operation). This offers the prospect of wastewater treatment process scale MFCs of relatively simple design producing significant electrical power, for example of the order of 100 Watts/m³ or more, preferably at least 500 Watts/m³ and more preferably at least 1000 Watts/m³. In one embodiment, the invention provides a MFC having an anode chamber that produces a power output of at least 20 mW, preferably at least 50 mW, more preferably at least 100 mW and especially at least 200 mW The invention also provides in a further aspect a waste treatment system comprising: an anode, a cathode, an electrolytic fluid, a substrate, a catalyst, a fluid chamber for containing waste water and a plurality of capacitive particles for transferring to the anode electrons generated in a reaction of a substrate at the catalyst to the anode, wherein the substrate is contained in waste water. For example, the substrate may be effluent in waste water from domestic or commercial sources such as sewage sludge, agricultural residues and organic by-products from industrial processes or agricultural products.

The invention further provides a fuel cell apparatus for use in the fuel cell of the invention. The fuel cell apparatus comprises an anode, a cathode, a fluid chamber and a plurality of capacitive particles. Advantageously the fuel cell apparatus further comprises a driving device (driver) for driving movement of the capacitive particles relative to the anode. Other features of the fuel cell described herein may be present in embodiments of the fuel cell apparatus.

The capacitive particles are solid particles capable of maintaining a charge whilst suspended in the fluid electrolyte of the cell. The capacitive particles are preferably synthetic particles. Synthetic particles are non-naturally occurring particles that are manufactured or synthesized. The capacitive particles preferably include at least one synthetic material. The particles may be constructed of more than one material. Preferably, the capacitive particles are composite in nature and comprise more than one material. The capacitive particles may comprise layers of different materials, for example in a laminated structure. The capacitive particles may comprise polymeric, metallic, oxides, ceramic or any other capacitively efficient material(s) including elemental carbon that enables the capacitive particles to accumulate and maintain a charge while suspended in the electrolytic liquid of the fuel cell. The capacitive particle may include metals, oxides of metals and/or activated carbon.

Preferably the particles comprise chemical capacitors or supercapacitors, which may be charged or discharged through the bulk of the particle. Chemical capacitors are compounds that undergo redox reactions to form charged ions, for example, a viologen compound. A suitable capacitive particle including a chemical capacitor is a particle comprising a composite of a viologen with conductive plastics (such as polypyrrol), metals, carbon black and/or activated carbon together with single and/or multi-walled carbon nanotubes. Suitable chemical capacitors are described by Kay H A, Kwan K J, Jeong K H, Seong C L, Dong J B, Young H L, in “High-capacitance supercapacitors using a nanocomposite electrode of single-walled carbon nanotube and polypyrrole” Journal of the Electrochemical Society, 2002, 149, (8), A1058-A1062 and by Frackowiak, E. in “Supercapacitors based on carbon materials and ionic liquids”, Journal of the Brazilian Chemical Society, 2006, 17 (6), 1074-1082. Chemical capacitors are able to be charged and discharged many times (of the order of 10⁵-10⁶ times) with more reversible characteristics than, for example, those of batteries. The voltammograms of the charging a discharging of chemical capacitors are typically close to being mirror images of each other. Chemical capacitors include materials that undergo an electrosorption processes in redox reactions at electrode surfaces or oxide films such as RuO₂ or Co₃O₄.

A “supercapacitor” (or an “ultracapacitor”) is an electrochemical device that has a higher specific capacitance than that achieved by a surface capacitor. Thus a supercapacitor is able to store energy more densely than a conventional capacitors. For example, a material with a capacitance of at least about 10-100 Farad/g could be considered to be a supercapacitor. Many supercapitors comprise chemical capacitors. Preferably the capacitive particles comprise a chemical supercapacitor. Preferably the capacitive particles are of a laminated construction including a supercapacitive material. For example, the capacitive particles may comprise electrochemical double-layer capacitors (EDLC). Electrochemical capacitors provide high specific capacitance (Farad/g) and so the efficiency of the capacitive particles and the system is maximised. Suitable supercapacitor devices comprising various materials such as metal oxides, conducting polymers and carbon, are described by Kay H A, et al, J. of the Electrochemical Society, 2002, 149, (8), A1058-A1062. Capacitive particles comprising conducting polymer materials are particularly preferred as are particles comprising materials which can be functionalised with reducible groups to provide a high bulk capacitance. It has been found that by including man-made fabricated particles in a fuel cell that are capable of acting as a capacitor to store electrical charge, more efficient transfer of charge from an electrochemical reaction site to a anode can be achieved.

The capacitive particles advantageously have an average capacitance of at least 0.1 pF (picoFarad) per particle, preferably at least 1 pF, more preferably at least 1 nF (nanoFarad) and especially at least 500 nF, for example, at least and average capacitance of 10 μF (microFarad) or greater per particle. In some particularly preferred embodiments the capacitive particles have an average capacitance of at least 0.01 Farad especially at least 0.05 Farad per particle. It has been found that a capacitance of approximately 0.05 Farad per particle can be achieved with a particle of about 1 mm³ and weighing about 1 mg (that is about 50 Farad per gram of particles). Advantageously, the capacitive particles have a capacitance of at least 10 Farad per gram of particles, preferably at least 30 Farad per gram, more preferably at least 50 Farad per gram and especially at least 100 Farad per gram. In particularly preferred embodiments the capacitive particles have a capacitance of at least 150 Farad per gram. Particles comprising composite materials have been found to be particularly preferred as they may enable high capacitances to be achieved, for example, of greater than 150 Farad per gram in some instances. Capacitive particles comprising supercapacitors such as carbon as part of a composite material or a supercapacitor device are particularly preferred due to the high capacitance that can be achieved.

Advantageously, the capacitive particles comprise a conductive material. Preferably the capacitive particles comprise a conductive material having a conductivity of at least 10⁻³ S/m, more preferably at least 10⁻² S/m and especially 10⁻¹ S/m. Advantageously, the conductive material is a conductive polymer. Preferably, the capacitive particles comprise a functionalized polymer, especially a polymer functionalized with reducible groups. Conductive polymers have a conductivity of at least 10⁻⁴ S/m. Suitable polymers include conjugated polymers which may have conductivities of up to approximately 10⁷ S/m. Examples of suitable conductive polymers include polypyrrole, polyacetylene polyaniline and polythiophene and their derivatives. The capacitive particle may also include metals, oxides of metals and activated carbon as a conductive material.

The capacitive particles are such that they are solid at room temperature and are preferably solid at 70° C. The particles are insoluble in the electrolytic fluid of the cell. Preferably the capacitive particles are insoluble in water. The particles are selected so as to be solid under the operating conditions of the cell of the invention. For example, MFCs typically comprise an aqueous anode chamber fluid and are operated at temperatures of up to around 55° C. and so particles used in an MFC of the invention should be solid at that temperature and insoluble in water.

The capacitive particles may be in the form of granules. The capacitive particles may be able to sustain a biofilm on their surface. The topology of the particle is advantageously such that discharge can occur at the electrode without disturbing any biofilm. The topology may be such that a biofilm that may exist on its surface is not disturbed. For example, the particle may have protuberances on the surface that contact the electrode. The capacitive particles may be porous. Porous capacitive particles may be able to sustain a biofilm in the pores. In some embodiments the capacitive particles are suspended in the moving electrolytic fluid. In those embodiments it is advantageous if the capacitive particles each have a sufficiently high coefficient of drag (C_{d}) to remain suspended in the electrolytic fluid by means of viscous forces. Preferably the capacitive particles each have a coefficient of drag (C_{d}) of at least 0.005, more preferably 0.01 and especially at least 0.1. In some embodiments the capacitive particles may have a coefficient of drag of at least 0.2 with particles having a drag coefficient of at least 0.4 being particularly preferred.

The capacitive particles advantageously each have an average volume of at least 0.1 mm³. Preferably, the capacitive particles each have an average volume of at least 0.5 mm³, more preferably at least 0.8 mm³ and especially at least 1 mm³. Preferably the capacitive particles each have an average volume of no greater than 10 mm³, more preferably no greater than 5 mm³ and especially no greater than 2 mm³. Capacitive particles with an average volume of from about 1 to about 2 mm³ have been found to be particularly suitable for use in the fuel cells of the invention. Advantageously, the capacitive particles each have an average major dimension of at least 0.05 mm, preferably at least 0.1 mm, more preferably at least 0.5 mm and especially at least 1 mm. In some embodiments the capacitive particles have an average major dimension of at least 2 mm, for example at least 5 mm. Advantageously, the capacitive particles each have an average major dimension of no more than 10 mm, preferably no more than 4 mm, more preferably no more than 2 mm and in some embodiments no more than 1 mm.

Advantageously, the capacitive particles each have an average higher specific gravity greater than the electrolytic fluid. Preferably, the capacitive particles each have an average specific gravity (with respect to pure water) of at least 1.0 and more preferably at least 1.05 and especially an average specific gravity of at least 1.1. In some embodiments the particles each have an average specific gravity of at least 1.5 with particles having an average specific gravity of from 1.5 to 2.0 being particularly preferred. The specific gravity of the electrolytic fluid in the fuel cells of the invention is typically approximately 1. Particles with a higher specific gravity than the electrolytic fluid will have a negative buoyancy in the still fluid and thus are separable by settling the capacitive particles. In some embodiments, the density of the capacitive particles is tailored to give desired settling rates. Advantageously, the capacitive particles each settle in the still electrolytic fluid at an average rate of at least 0.1 m/min, preferably at least 0.5 m/min and especially at least 1 m/min. In fuel cells of the invention, in particular large scale reactors, settling rates of at least 5 m/min may be advantageous. In some embodiments, the specific gravity of the capacitive particles is lower than the electrolytic fluid thus the capacitive particles are buoyant in the still fluid and thus are separable from the bulk of the electrolytic fluid.

Advantageously, the capacitive particles each have an average threshold potential for charging of at least −50 mV, preferably at least −100 mV, more preferably at least −150 mV, still more preferably at least −200 mV and especially at least −250 mV with reference to the Standard Hydrogen Electrode. It has been found that capacitive particles having average threshold potentials of at least −300 mV and especially at least −350 mV are particularly advantageous with capacitive particles having an average threshold potential of at least −400 mV with reference to a Standard Hydrogen Electrode being highly preferred. The charge in Coulombs stored in a capacitor is related to the voltage therefore, the higher the potential difference (V), the higher the stored energy. i.e. C=FV where C-coulombs (charge), F-Farad (capacitance) and V-volts (potential difference). Accordingly the lower the threshold potential of capacitor (i.e the more negative), the greater the charge storing ability. Accordingly an average minimum threshold potential of −185 mV is desirable. For the avoidance of doubt a threshold potential of at least −50 mV means a threshold potential of −50 mV or lower, i.e. a more negative voltage.

The more closely the threshold potential is matched to the free energy available from the catalysed electron-production process, for example a microbe catalysed electron-production process, then the more efficient is the energy harvesting. For example, the potential for pyruvate to lactate is about −185 mV, and the potential for the conversion of NAD to NADH is about −320 mV, and the potential for H₂ is −420 mV. Thus, fuel cells in which electron production involves one or other of those processes are expected to have an enhanced efficiency if the cells contain capacitive particles that each have a threshold potential that approximately match the potential of the active electron-production process. Systems comprising capacitive particles having a range of threshold potentials, for example, a range of at least 100 mV are also highly desirable as energy harvesting over a wide window of the catalysed electron production process is possible. Preferably, the fuel cell of the invention comprises a plurality of capacitive particles having a range of threshold potentials of at least 200 mV, more preferably a range of at least 300 mV and especially a range of at least 400 mV.

Advantageously, the threshold potential of each of the capacitive particles in no more than −1000 mV, preferably no more than −800 mV and more preferably no more than −650 mV. For the avoidance of doubt, a threshold potential of no more than −1000 mV means a potential no more negative than −1000 mV, that is a potential of −1000 mV or a less negative voltage. The maximum potential known to be achieved by bacteria that are suitable for use in an MFC is around −650 mV. Capacitive particles with a potential of from −180 mV to −500 mV are most preferred as such potentials are matched to the free energy available form the electron production processes of most bacteria. Preferably the capacitive particles have a range of potentials from −180 mV to −500 mV, such that they intervene in the bacterial electron transport chain at various points (and potentials). Advantageously, a MFC of the invention includes a plurality of capacitive particles having a plurality of threshold potentials in the range of from −180 mV to −500 mV.

Preferably the capacitive particles are such that they rapidly discharge on contact with the anode. Advantageously, the capacitive particles have rapid charge discharge kinetics. Preferably, each of the capacitive particles discharge in an average of no more than 2 seconds, preferably no more than 1 second, more preferably no more than 0.8 seconds and especially no more than 0.5 seconds. Average discharge times of no more than 0.1 seconds are particularly advantageous with average discharge times of no more than 0.01 seconds and especially no more than 0.005 seconds being preferred. Average discharge times of no more than 1 ms are particularly preferred. The discharge time is defined at the average time taken for a charged capacitive particle to discharge 63% of the stored charge when brought into contact with an anode having a potential of greater than the threshold potential of the capacitive particle and assuming characteristic first order discharge behaviour. The discharge kinetics determines the rate at which the charge is depleted in the particle and transfers to the electrode. Discharge kinetics are measured by connecting a charged particle to a charge measuring instrument and a known (selected) load which exemplifies the anode electrode condition while measuring the residual charge over time.

This is expected to have approximately first order dynamics (not withstanding the threshold voltage) as some resistance will be involved, consequently the time constant of such a system will define the kinetics. The time constant is a parameter intrinsic to any linear time-invariant first order dynamic system and is defined as the time taken to reach 0.63 of the final value after a step input. Rapid charge discharge kinetics may enable the particles to rapidly discharge charge on contact with an anode having a potential greater than the threshold potential. Ideally, the discharge time will be no higher than 1 second.

Discharging the energy stored in the capacitive particles occurs on contact with the anode in a closed circuit. This discharge can be continuous with the charged particles randomly or by forced convection encountering the anode material or it may be intermittent with discharge taking place when, for example, 80% or more of the total capacitance of the particles has been achieved, or it may involve separation and concentration of the charged particles in a separate compartment or region of the fluid chamber in which an anode is present. The advantages of intermittent separation and concentration procedures is that a higher power output can be achieved because discharge can take place at a higher rate.

In a preferred embodiment the cell is a MFC, and the catalyst is a bacteria that generates electrons on consumption of a substrate. The capacitive particles receive electrons from the bacteria and store these electrons. The mechanism involves the charging of the capacitive particle, for example, by means of known MFC processes such as mediated electron transfer, direct reduction by contact transfer of electrons from the bacteria, or reduction through nanowires or immobilised mediators, such as viologens, on the particle surface. The capacitive particles may be charged through a combination of more than one mechanism, for example, direct electron transfer from bacteria to mediator species immobilised on the particle surface and then to the body of the capacitive particle. The bacteria in the system may be planctonic (freely suspended individuals), in flocs, in grains, in biofilms or immobilised on the capacitive particles, for example as biofilms on the capacitive particles, or in transition between or a combination of any of those states. The bacterium may include one or more of Clostridia, E-Coli, Bacillus, Shewenella, Rhodofarax and Psudomonas. Such bacteria are particularly suitable for use in fuel cells of the invention in which the bacteria is planctonic or in flocs and grains. The bacteria may include anodophilic species. Anodophilic species attach themselves directly onto an electron acceptor surface such as an anode and transfer electrons from their electron transfer pathways to the electron acceptor. Examples of anodophilic bacteria include Geobacter species such as Geobacter sulfurreducens and Rhodoferax ferrireducens. Anodophilic bacteria have been found to directly reduce the capacitive particle by direct contact processes and are particularly suited to use in cells in which the bacteria is immobilised on the capacitive particles.

In a further embodiment the cell is a conventional, non-biological, fuel cell. In a conventional fuel cell of the invention, the particles function as a mechanism to transfer electrons from electrochemical reaction catalysed by a non-biological catalyst to the anode of the cell. The reaction site may be distributed in the fluid, for example as catalyst beads. Alternatively the catalyst may be localised, for example as a catalyst mesh. In a preferred embodiment the capacitive particles include the catalyst, for example, as a coating on the surface of the particles.

Preferably, the capacitive particles include the catalyst. The catalyst may be immobilised on or in the capacitive particles. Preferably, the catalyst is immobilised on or in the capacitive particles as opposed to being immobilised on an alternative structure within the cell or freely suspended in the electrolytic fluid. Immobilisation of the catalyst encompasses chemical or physical bonding of the catalyst to the capacitive material of the particles, for example on or in the surface of the capacitive particles, and incorporation of the catalytic material into the capacitive particle structure. In one embodiment the capacitive particles comprise an inorganic catalyst, for example as a coating. In another embodiment the capacitive particles comprise bacteria. The capacitive particles may be arranged so that bacteria congregate or grow on the particles, for example, as a biofilm on the surface of the particles or as flocs in pores on the capacitive particles. In some preferred embodiments, the capacitive particles carry a biofilm including bacteria.

Preferably, a redox mediator is present and charge is transferred from the reaction site to the capacitive particles by mediated electron transfer. The mediator may be a natural or a synthetic mediator. The redox mediator is preferably reduced by electrons produced in an electrochemical reaction to form anions. For example, the mediator may be reduced by electrons derived from the electron transfer chain of bacteria. The redox mediator anions may be are oxidised by the capacitive particles in the same way that they are oxidised by an anode in a conventional mediated MFC. Synthetic organic compounds having conjugated π-bonds, especially compounds having aromatic and/or heteroaromatic rings, are preferred mediators. The delocalised π-bonded systems of such compounds are electron acceptors and so are readily reduced. The mediator may include a dyestuff. The mediators may include a viologen. Examples of potentially suitable mediators include Neutral Red, Methylene blue, Amido black, thionine, menaquinone, pyocyonin and phenazines.

The mediators may be immobilised on the capacitive particles, for example in or on the capacitive particle surface. In a preferred embodiment the mediator is a chemical capacitor. The chemical capacitor may thus provide a means of storing charge at low potentials. Preferably the capacitive particles comprise a composite material that includes a redox mediator. For example, the capacitive particles may comprise a composite material, wherein the composite material includes a substance which is a chemical capacitor that functions as a redox mediator.

Charge may be transferred directly from the bacteria or other electron generating site by way of an unmediated electron transfer mechanism. For example, in embodiments where electrons are generated by anodophilic bacteria such as the bacterium Geobacter, electrons may be transferred through direct contact of the capacitive particles with the bacteria. Electrons may be transferred from the reaction site to the capacitive particles through nano wires. The use of nano wires for transferring electrons from bacteria to fuel cell anodes has been described, for example by Gorby, Y. A. et al. in “Electrical conductive bacterial nanowires . . . ”, Proc. Natl. Acad. Sci. USA, 2006, 103, 11358-11363.

Advantageously the fuel cell comprises a driver for driving movement of the capacitive particles. The driver may be a means for causing a flow of the electrolytic fluid in which the capacitive particles are or become suspended such as a pump, paddle or localised heat source that generates a convection current in the fluid. Alternatively, the driver may act upon the capacitive particles. For example, the driver may be an electrical or magnetic field generating means that causes capacitive particles to move in an electrical or magnetic field. The particles may move by a recirculatory flow. Alternatively, the capacitive particles may randomly diffuse through the fluid. The capacitive particles may be temporarily allowed to settle. Preferably the operation of the fuel cell includes a step of settling the particles. The settling may be controlled by a change in the operation of the driver, for example due to the removal or reduction of an applied electrical or magnetic field, removal or reduction of an up flow of the electrolytic fluid or a change in the degree of agitation of the electrolytic fluid. Preferably, the driver is capable of being operated intermittently.

An up-flow or other flow pattern in the reactor may be employed to maintain the capacitive particles suspended in the electrolytic fluid. Whilst in the electrolytic fluid the capacitive particles come into contact with suspended and/or dissolved substrate and, in embodiments where the catalyst is not immobilised on the particles, the catalyst. The capacitive particles may be allowed to periodically settle or contact the anode that is made of a conducting material. On contact with the anode, the capacitive particles discharge the electricity into a anode/cathode/load arrangement. The periodic contact may be achieved in several ways such as by reducing an up-flow velocity, by virtue of the reactor shape as is the case in circulating reactors, cyclones or fluidised bed reactors, by random action or by a forced flow that impinges on the anode. Preferably, the capacitive particles resemble the density and dimensional scale of microbial granules as evident in EGSB (Expanded Granular Sludge Bed), fluidised bed or UASB (Upflow Anerobic Sludge Blanket) high rate anaerobic digestion reactors. Conventional microbial granules have a major dimension of from 0.1 to 10 mm and have a specific gravity greater than the electrolytic fluid such that they would settle at an average rate ranging from approximately 5 m/min or faster, to 0.1 m/min or slower. In systems in which microbial granules are made more buoyant by gas evolution by the bacteria, a sludge blanket may be developed to retain the biomass.

In some embodiments, the capacitive particles may be periodically concentrated in the region of the anode. The capacitive particles may be periodically separated from the electrolytic fluid of the fuel cell. In a preferred embodiment the fluid chamber may comprise a plurality of compartments or regions. The regions of the fluid chamber may be distinct areas within the fluid chamber, for example, the anode may be present in one area and absent from another area. The fluid chamber may be divided into a plurality of interconnected compartments. In an alternative embodiment the anode may be distributed throughout the fluid chamber. Advantageously, the fluid chamber comprises a first compartment or region and a second compartment or region in which the anode is present (the anode compartment or region). The substrate may be concentrated in the first compartment or region. The capacitive particles may move between the first and second compartments or regions. The capacitive particles may be periodically separated from a first compartment or region, in which substrate is concentrated in the electrolytic fluid and where electrochemical processes are active to charge the particle, and concentrated into a second compartment or region, in which the particles come into contact with an anode to discharge electrons. Preferably, the fuel cell comprises a separator for concentrating the capacitive particles in the anode compartment or region. In embodiments in which the fuel cell includes a driving means, the driving means may function as a separator. The capacitive particles may be separated from the first compartment or region and/or concentrated in the second compartment or region by any suitable separation mechanism including filtration, hydrodynamic processes, as a result of the density or buoyancy of the particles or by magnetism. Separation techniques or recirculatory techniques may periodically translate the particles from one flow pattern in the fuel cell to another. In one embodiment an up flow velocity within the anode chamber may be regulated so that capacitive particles that have a higher specific density than the electrolytic fluid periodically settle to the bottom of the fluid chamber where an anode is present and are thus concentrated in the anode region. In another embodiment, a filter is used to periodically remove capacitive particles from a flow of electrolytic fluid into the compartment or region in which the anode is present.

In some embodiments the fuel cell is operated so that the charged capacitive particles are concentrated prior to discharge at the anode. The fuel cell may be arranged so that charged capacitive particles accumulate in the compartment or region in which the anode is present. Preferably, a selector selectively concentrates charged capacitive particles into the compartment or region of the fluid chamber in which the anode is present. Preferably, the charged capacitive particles are selectively separated from a first compartment or region, in which substrate is concentrated in the electrolytic fluid and where electrochemical processes are active to charge the capacitive particle, and concentrated in a second compartment or region, in which the capacitive particles come into contact with an anode to discharge electrons. Separation techniques or recirculatory techniques may selectively translate the charged capacitive particles from one flow pattern in the fuel cell to another. Preferably the charged capacitive particles are separated from the uncharged particles prior to contact with the anode. Magnetic separation can be achieved by using the magnetic properties of the charged capacitive particle which is electronegative by virtue of the accumulated electrons. Consequently charged capacitive particles may be deviated from a particular vector of travel using a magnetic field to an alternative vector which results in them coming into contact with the anode or being diverted into an anode compartment or region. In a preferred embodiment, the charged capacitive particles are accumulated in the region of the anode under the influence of an electrical or magnetic field. A minimum level of charge may be required before the particles will be sufficiently influenced by a magnetic field or electric field to move into the anode compartment or region. The selector may a be a device that generates an electrical or magnetic field Advantageously, each charged capacitive particle is separated from the uncharged capacitive particles once it has reached a minimum level of charge. Advantageously, the selector selectively accumulates capacitive particles with a minimum level of charge in the anode compartment or region. Preferably the capacitive particles are separated at a charge of at least −1.6×10⁻¹⁶, more preferably a charge of at least −1.6×10⁻¹³ coulombs. Preferably, the capacitive particles are separated when at least 50% of the total capacitance of the particle is reached, more preferably at least 70% and especially at least 80% of the total capacitance. The uncharged or incompletely charged capacitive particles may be distributed throughout the electrolytic fluid. Advantageously, the uncharged or incompletely charged capacitive particles are concentrated in the region or compartment of the fluid chamber in which substrate is concentrated. The uncharged particles may be selectively separated from the compartment or region in which the anode is present.

The cathode arrangement of the cells of the invention may be any suitable cathode arrangement. In the case of an MFC, the cathode may be, for example, an air cathode or submerged cathode in aerated water or other oxidising media.

It is to be understood that although optional features described as “preferred” are advantageous in some embodiments of the invention, the presence of those features may not be desirable in other embodiments and may be absent from those embodiments.

### DESCRIPTION OF DRAWINGS

FIG. 1 shows a schematic view of the anode chamber of a fuel cell of the invention.

### SPECIFIC EMBODIMENTS OF THE INVENTION

There will now be described specific embodiments of the invention for illustrative purposes. It is to be understood that features of those embodiments may be incorporated into other embodiments of the invention where appropriate.

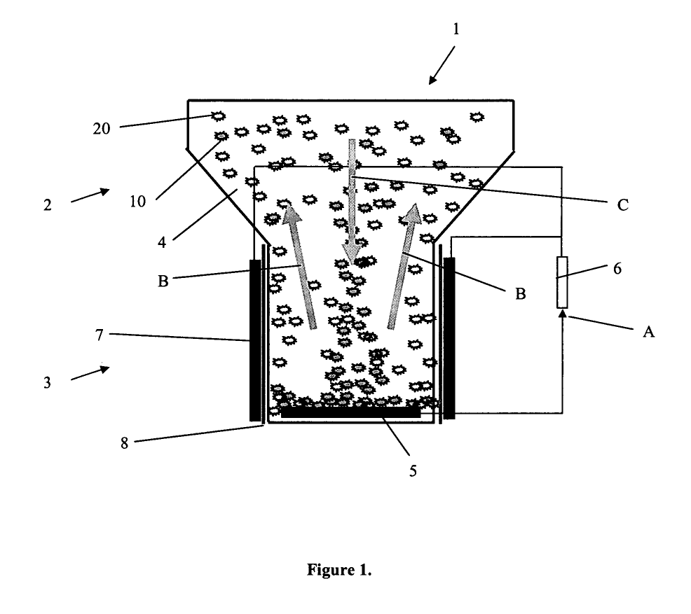

FIG. 1 shows an embodiment of a fuel cell according to the invention. The fluid chamber 1 of the fuel cell reactor includes an upper portion 2 and a lower portion 3. The fluid chamber 1 contains an electrolytic fluid 4 that is an aqueous electrolyte. The upper portion 2 is a hopper-shaped vessel in which substrate (not shown) is loaded into the electrolytic fluid 4. An anode 5 made of conductive material is provided in the lower portion 3 of the fluid chamber 1. The anode 5 is connected via a load 6 to a pair of cathodes 7. The cathodes 7 are separated from the fluid chamber 1 by an ion exchange membrane 8 that is positioned in contact with a perforated surface of the anode chamber 1. Electrons pass from the anode 5 to the cathode 7 in an external circuit in the direction of the arrow A via the load 6. Positive charge is conveyed from an electrochemical reaction site in the electrolytic fluid 4 of the fluid chamber 1 to the cathode 7 by cations. The cations travel via the ion exchange membrane 8. Charged capacitive particles 10 and uncharged or incompletely charged capacitive particles 20 are present in the electrolytic fluid 4. The charged particles 10 transfer electrons from the electrochemical reaction site to the anode 5, thereby completing the electrical circuit. Waste products are of the electrochemical reaction are removed from the electrolytic fluid by a waste removal means (not shown). The waste removal means may include a gas outlet for allowing gaseous by-products to escape or a filter system for removing waste solid material.

In one embodiment, the electrolytic fluid 4 is an aqueous anaerobic liquid electrolyte including freely suspended (planctonic) mixed population of electrogenic bacteria including Clostridia, E-Coli, Bacillus, Shewenella, Rhodofarax and Psudomonas bacteria (not shown) and composite capacitive particles 10, 20 comprising a viologen and polypyrrole. In an alternative embodiment of the fuel cell of the invention, bacteria is present on the surface of the capacitive particles 10,20 as a biofilm including some of the species mentioned above and also Geobacter species that is able to directly reduce the particle by direct contact processes. In a further embodiment, in which the fuel cell operates as a conventional hydrogen fuel cell and the substrate (not shown) is hydrogen gas that disassociates to form protons and electrons, the capacitive particles 10,20 include a capacitive core of laminated polymer layers and a Pd/Pt (palladium/platinum) catalyst coating.

In a circulatory mode of operation, pumping, magnetic flux or natural convection of the liquid phase (electrolytic fluid 4) in the anode chamber 1 causes the suspended particulates, including capacitive particles 10,20, to circulate in the direction of arrows B up the outside of the lower portion 3 of the fluid chamber 1 into the upper portion 2. During the period of suspension in the electrolytic fluid 4, uncharged capacitive particles 20 will receive charge by way of direct electron transfer from the bacteria species thereby becoming charged capacitive particles 10. The particles 10,20 circulate back down the centre of the anode chamber 1 in the direction of arrow C and on impinge on anode 5. The anode 5 is maintained at a potential of at least −440 mV (with reference to a hydrogen electrode). On contact with the anode 5 the charged particles 10 discharge.

In a batch mode of operation, the electrolytic fluid 4 is periodically agitated to bring the predominantly uncharged particles 20 into suspension in the electrolytic liquid 4 where they come into contact with the bacteria. When the agitation is ceased, the charged particles 10 are allowed to settle into the bottom of the lower portion 3 where they come into contact with the anode 5 and release electrons. In an alternative batch mode of operation, separator (not shown) applies a magnetic field to the anode chamber 1. Capacitive particles 10 that include a sufficient level of charge migrate into the lower portion 3 of the fluid chamber 1 (that is the region of the fluid chamber 1 in which the anode 5 is present) under the influence of the magnetic field, contact the anode 5 and discharge. The buoyancy of the uncharged particles 20 is such that they rise into the upper portion 2 where they come into contact with higher concentrations of substrate.

In a continuous loading mode of operation, substrate suspended and/or dissolved in electrolytic fluid 4 is loaded into the top hopper of the upper portion 2 of the fluid chamber 1 as a continuous flow. Waste products are also continuously separated from the unreacted substrate, capacitive particles 10,20, and catalyst by a filtration means (not shown) and are withdrawn through an outlet (not shown) together with excess electrolytic fluid 4. In a batch loading mode of operation, a batch of substrate and electrolytic fluid 4 is loaded into the hopper of the upper portion 2 of the fluid chamber 1. The substrate is consumed in the electrochemical reactions of the fuel cell generating electrical charge. Once the substrate is consumed the spent substrate and waste products are separated from the catalyst and the capacitive particles 10, 20 and are discharged together with the electrolytic fluid 4.

1. A fuel cell comprising an anode, a cathode, a catalyst, an electrolytic fluid, a substrate, a fluid chamber and a plurality of capacitive particles for transferring electrons generated in an electrochemical reaction to the anode wherein the capacitive particles are mobile particles that are capable of storing electrical charge.

2. The cell according to claim 1, wherein the cell is a microbial fuel cell (MFC) and the catalyst comprises bacteria.

3. (canceled)

4. The cell of claim 1, wherein the capacitive particles have a charging threshold potential of at least −80 mV with respect to a Standard Hydrogen Electrode.

5. The cell of claim 1, wherein each capacitive particle has an average capacitance of at least 0.1 pF.

6. The cell of claim 1, wherein the capacitive particles comprise a synthetic material.

7. The cell of claim 6, wherein the capacitive particles comprise a composite material.

8. The cell of claim 1, wherein the capacitive particles comprise a chemical capacitor.

9. The cell of claim 1, wherein the capacitive particles each have an average volume of at least 0.1 mm³.

10. (canceled)

11. The cell of claim 1, wherein the capacitive particles include the catalyst.

12. The cell of claim 1, wherein the capacitive particles include a redox mediator.

13. The cell of claim 1, wherein the capacitive particles each have a specific gravity of at least 1.0.

14. (canceled)

15. The cell of claim 1, further comprising a driver for driving movement of the capacitive particles.

16-19. (canceled)

20. A method of operating a fuel cell comprising an anode, a cathode, a fluid chamber, a catalyst, a electrolytic fluid, a substrate and a plurality of mobile capacitive particles that are capable of storing electrical charge, the method including the steps of: a. generating electrons in an electrochemical reaction involving the substrate that is catalysed by the catalyst; b. charging the capacitive particles with the electrons; c. moving the capacitive particles or allowing the capacitive particles to move relative to the anode; and d. discharging electrons from the capacitive particles to the anode.

21. The method of claim 20, including the step of concentrating charged capacitive particles prior to discharging electrons from the charged capacitive particles to the anode.

22-23. (canceled)

24. A synthetic capacitive particle able to carry charge produced in an electrochemical reaction in a fuel cell to an anode, wherein the particle is suitable for use in the cell of claim 1.

25. The synthetic capacitive particle of claim 24, wherein the capacitive particle has a capacitance of at least 0.1 pF.

26. The synthetic capacitive particle of claim 24, wherein the capacitive particle comprises a chemical capacitor.

27. A plurality of the synthetic capacitive particles of claim 24, wherein the plurality of capacitive particles have a range of potentials from about −180 mV to about −500 mV with respect to a Standard Hydrogen Electrode.

28. A waste treatment system including the cell of claim 1.

29. A fuel cell apparatus comprising an anode, a cathode, a fluid chamber and a plurality of mobile capacitive particles that are capable of storing electrical charge.
